(19) United States
(12) Patent Application Publication
(10) Pub. No.: US 2008/0096081 A1
(43) Pub. Date: Apr. 24, 2008

(54) Fuel Cell

(75) Inventor: Atsushi Miyazawa, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD., YOKOHAMA-SHI, KANAGAWA (JP)

(21) Appl. No.: 11/661,779

(22) PCT Filed: Sep. 9, 2005
(86) PCT No.: PCT/JP05/17096

§ 371 Date: Mar. 2, 2007

(30) Foreign Application Priority Data
Sep. 14, 2004 (JP) 2004-266747

(51) Int. Cl. H01M 8/02

(52) U.S. Cl. 429/34

(57) ABSTRACT

A fuel cell system which includes: a fuel cell fed with a reaction gas for generating power; an output detection unit which detects output current and voltage of the fuel cell; a storage unit which stores a standard current-voltage characteristic of the fuel cell, from which a standard voltage of the fuel cell at an output current thereof is obtainable; and a gas feed mismatch detection unit which detects a gas feed mismatch of the reaction gas, based on a comparison between the detected output voltage of the fuel cell and the standard voltage at the detected output current, obtained from the standard current-voltage characteristic stored.

### TECHNICAL FIELD

The present invention relates to a fuel cell and, more particularly, to a fuel cell having a structure to prevent metal ions from diffusing into an electrolyte membrane and a catalyst layer.

### BACKGROUND ART

In recent years, proposals have heretofore been made to provide a fuel cell that includes a fuel cell stack adapted to be supplied with fuel gas, containing hydrogen, and oxidizer gas, containing oxygen, to cause electrochemical reaction to take place on an electrolyte composed of solid polymer for thereby permitting electrical energy to be directly extracted from between electrodes.

The fuel cell operates on an electrochemical reaction described below.
Anode Electrode Reaction: H₂→2H⁺+2e⁻ (1)
Cathode Electrode Reaction: 2H⁺+2e⁻+(½)O₂→H₂O (2)

That is, as the fuel electrode (anode), serving as a positive electrode, is supplied with fuel (hydrogen) gas, oxidizing reaction takes place as shown in the above formula (1) due to the presence of a catalyst, thereby generating hydrogen ions (H⁺, protons) and electrons. The hydrogen ions have peripheries accompanied with several water molecules in a hydration state and move from the fuel electrode to the oxidizer electrode (cathode) serving as the negative electrode through a polymer electrolyte. In the meantime, the electrons move through the electrode with an electron conductivity and moves into the cathode through an external load circuit. The electrons, entering from the external circuit, and the hydrogen ions, moving though the polymer electrolyte, result in reduction reaction that proceeds on the cathode on the above formula (2) due to oxygen contained in air supplied from an outside, thereby generating product water.

Here, a solid polymer electrolyte, for use in a solid polymer fuel cell, does not offer favorable hydrogen ion conductivity in the absence of a wet condition and the hydrogen ions, dissociated on the anode, move through the electrolyte into the cathode under a hydration state. Thus, probabilities occur on an area close proximity to an anode surface of the electrolyte with the occurrence of a shortage in water and a need arises for water to be replenished in order to allow electric power to be continuously generated. Such replenishing of water is achieved by humidifying fuel gas, to be supplied to the anode. Also, replenishing of water is achieved by humidifying air, that is, oxidizer gas, to be supplied to the cathode.

Further, it has been proposed to provide a structure wherein fuel gas, to be supplied to the fuel electrode, is directly supplied from a hydrogen storage device, that is, a structure wherein hydrogen containing gas, obtained upon reforming fuels such as gasoline, alcohol and natural gas, is directly supplied. The hydrogen storage device includes a high pressure tank, a liquefied hydrogen tank and a hydrogen storage alloy. In the meanwhile, it has been a general practice to utilize air as oxidizer gas to be supplied to the oxidizer electrode.

Such a fuel cell is structures such that an electrolyte membrane has one surface formed with a fuel electrode and the other surface formed with an oxidizer electrode and a separator, formed with a fuel gas flow channel, is located on the fuel electrode while a separator, formed with an oxidizer gas flow channel, is located on the oxidizer electrode, thereby forming a unit fuel cell (hereinafter merely referred to as a unit cell) serving as a fuel cell supplied with fuel gas and oxidizer gas to generate electric power (with electromotive force being created). A plurality of such unit cells are stacked to form a stack body that has both ends provided with terminal members such as current collector plates, insulation plates and end plates, respectively, to form a fuel cell stack.

Further, in general, the separator has an outer peripheral area, beyond a region formed with the fluid channel, which is formed with through-holes through which tightening bolts penetrate, gas manifolds through which various gases are delivered to flow channels formed on a separator surface, and gaskets through which adjacent stack layers are fixedly secured.

In addition to the presence of high electric power generating efficiency, such a fuel cell has an advantage with clean emissions and can be utilized in stationary type power generations such as an electric power generation plant and an electric power generator for domestic use. Moreover, with a solid polymer fuel cell that employs a solid polymer as en electrolyte membrane, since operating temperatures are low as high as room temperature to 100° C. and a startup time interval is short with the other advantages of high output power density and small and light in structure, a spotlight has been recently cast on technologies to be utilized as a power drive source of a vehicle with a view to providing a fuel cell powered automobile.

With such a solid polymer fuel cell, since a voltage of a unit cell lies at a value as low as approximately 1 [V] during power output on load, when desired to use a vehicle drive power supply, in general, there are many probabilities in which several hundreds of cells are stacked in a structure of a fuel cell stack wherein the unit cells are connected in series to obtain an output voltage of several hundreds volts.

Further, although it is a usual practice for the separator to be composed of a carbon family separator resulting from press forming composite material with principal components of graphite, resin and graphite powder, in cases where in recent years, it is intended to particularly install a fuel cell in a moving object (such as an automobile), a need arises for miniaturization in structure and accompanied improvement over an output power density and, so, there has been an increase of research and development into a metal separator available to achieve a thin configuration.

However, in using a metal product as a separator, there is a need for addressing a phenomenon in which metal is partly subjected to corrosion due to atmospherics inside the fuel cell and Japanese Patent Application Laid-Open Publication No. 05-234606 (on pages 3 and 4, in FIGS. 1 and 2) and Japanese Patent Application Laid-Open Publication No. 2003-331905 (on pages 4 and 5, in FIGS. 1 and 2) disclose structures attempting to address such an issue with the occurrence of corrosion of the separator.

### DISCLOSURE OF INVENTION

However, upon studies conducted by the present inventor, typically in cases where metal ions, dissolved from the metal separators, are present inside the fuel cell, the metal ions diffuse into the electrolyte membrane wherein if the electrolyte membrane contains sulfonic acid ions, the metal ions and the sulfonic ions bind together. This results in a tendency with the occurrence of inhibition to the movement of generated protons through the electrolyte membrane with the resultant deterioration in electric power generation efficiency. Also, if particular metal ions are generated, these ions trigger to cause radicals to generate on the cathode, resulting in a tendency in which molecular chains inside the electrolyte membrane are caused to be broken.

Furthermore, if the metal separator is used, suppressing the dissolving of metal ions resulting from characteristics of material and a few scratches on a surface is attended with various difficulties on a real practice.

Here, the dissolving ions depend on cell temperature, a humidification rate and potential and the metal ions, locally dissolved inside the cell, seem to diffuse in opposing electrode surfaces through the same electrode and the membrane.

Therefore, with a structure wherein a reactive area, carrying catalyst, is formed over the electrolyte membrane and through-holes (manifolds) are processed in areas associated with gateways for fluids, a decrease occurs in a distance between an outlet manifold and an adjacent inlet manifold depending on a way in which the manifolds are located, resulting in the occurrence of diffusion of the metal ions due to concentration gradient with the resultant issues of the metal ions diffused over an entire surface of the electrolyte membrane.

Moreover, although it seems that probabilities occur for the metal ions to be supplied from temperature conditioning medium circulating through the cells, the metal ions have a tendency to diffuse from a manifold for temperature conditioning medium to an adjacent inlet manifold for reaction gas.

The present invention has been completed under review of such studies conducted by the present inventor and has an object to provide a fuel cell that is enabled to prevent metal ions from diffusing through an electrolyte membrane for thereby suppressing deterioration in the electrolyte membrane.

One aspect of the present invention provides a fuel cell comprising: an electrolyte membrane; a fuel electrode catalyst layer disposed on a first surface of the electrolyte membrane; a fuel electrode separator disposed on the fuel electrode catalyst on a side thereof in opposition to the electrolyte membrane and having a fuel gas flow channel; an oxidizer electrode catalyst layer disposed on a second surface of the electrolyte membrane, the second surface being in opposition to the first surface; an oxidizer electrode separator disposed on the oxidizer electrode catalyst on a side thereof in opposition to the electrolyte membrane and having an oxidizer gas flow channel; a plurality of manifolds formed in the electrolyte membrane and permitting at least one of fuel gas, oxidizer gas and temperature conditioning medium to flow; and an ion diffusion preventive region provided on at least one open end peripheral edge portion of the plurality of manifolds to prevent ions, contained in fluid flowing through the at least one of the plurality of manifolds, from diffusing.

Another aspect of the present invention provides a fuel cell comprising: an electrolyte membrane; a fuel electrode catalyst layer disposed on a first surface of the electrolyte membrane; a fuel electrode separator disposed on the fuel electrode catalyst on a side thereof in opposition to the electrolyte membrane and having a fuel gas flow channel; an oxidizer electrode catalyst layer disposed on a second surface of the electrolyte membrane, the second surface being in opposition to the first surface; an oxidizer electrode separator disposed on the oxidizer electrode catalyst on a side thereof in opposition to the electrolyte membrane and having an oxidizer gas flow channel; a plurality of manifolds formed in the electrolyte membrane and permitting at least one of fuel gas, oxidizer gas and temperature conditioning medium to flow; and preventing means for preventing ions, contained in fluid flowing through the at least one of the plurality of manifolds, from diffusing, the preventing means being provided on at least one open end peripheral edge portion of the plurality of manifolds.

Other and further features, advantages, and benefits of the present invention will become more apparent from the following description taken in conjunction with the following drawings.

### BRIEF DESCRIPTION OF DRAWINGS

FIG. 1 is a schematic structural view of a fuel cell system of a first embodiment according to the present invention;

FIG. 2 is a cross-sectional view showing a fuel cell (fuel cell stack) in the fuel cell system of the presently filed embodiment in an enlarged scale;

FIG. 3A is a front view of a membrane electrode assembly as viewed in a direction X on FIG. 2;

FIG. 3B is a cross-sectional view taken on line A-A of FIG. 3A;

FIG. 4A is a partial front view of a membrane electrode assembly of a fuel cell of a second embodiment according to the present invention with the positional correlation corresponding to that of FIG. 3A;

FIG. 4B is a partial cross-sectional view taken on line B-B of FIG. 4A;

FIG. 5A is a partial cross-sectional view of an essential component part, prior to execution of ion diffusion preventive processing, of a membrane electrode assembly of a fuel cell of a third embodiment according to the present invention;

FIG. 5B is a partial cross-sectional view of the essential component part, subsequent to ion diffusion preventive processing being conducted, of the membrane electrode assembly of the fuel cell of the presently filed embodiment;

FIG. 6A is a partial cross-sectional view of an essential component part, prior to execution of ion diffusion preventive processing, of a membrane electrode assembly of a fuel cell of a fourth embodiment according to the present invention;

FIG. 6B is a partial cross-sectional view of the essential component part, subsequent to ion diffusion preventive processing being conducted, of the membrane electrode assembly of the fuel cell of the presently filed embodiment;

FIG. 7A is a partial cross-sectional view of essential component parts, prior to execution of ion diffusion preventive processing, of a diffusion layer and the membrane electrode assembly of the fuel cell of the fourth embodiment according to the present invention; and

FIG. 7B is a partial cross-sectional view of essential component parts, subsequent to ion diffusion preventive processing being conducted, of the diffusion layer and the membrane electrode assembly of the fuel cell of the presently filed embodiment.

### BEST MODE FOR CARRYING OUT THE INVENTION

Hereinafter, fuel cells of various embodiments according to the present invention are described in detail with reference to the accompanying drawings.

### First Embodiment

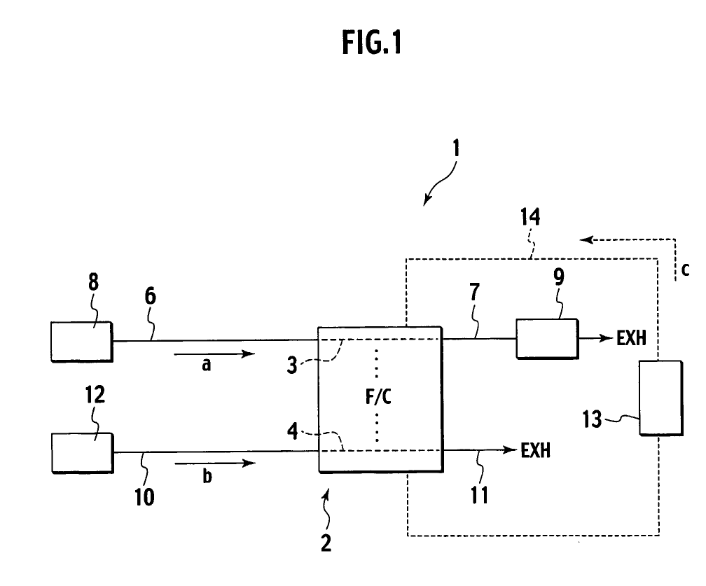

First, referring to FIGS. 1 to 3B, a fuel cell of a first embodiment according to the present invention is described in detail.

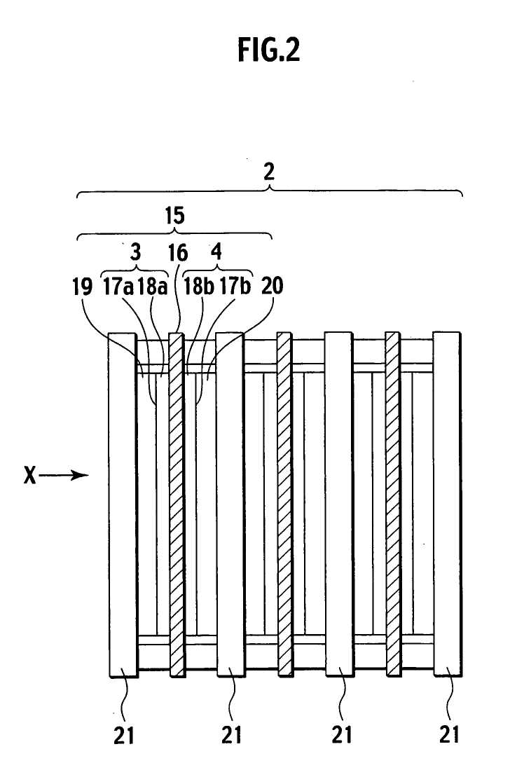

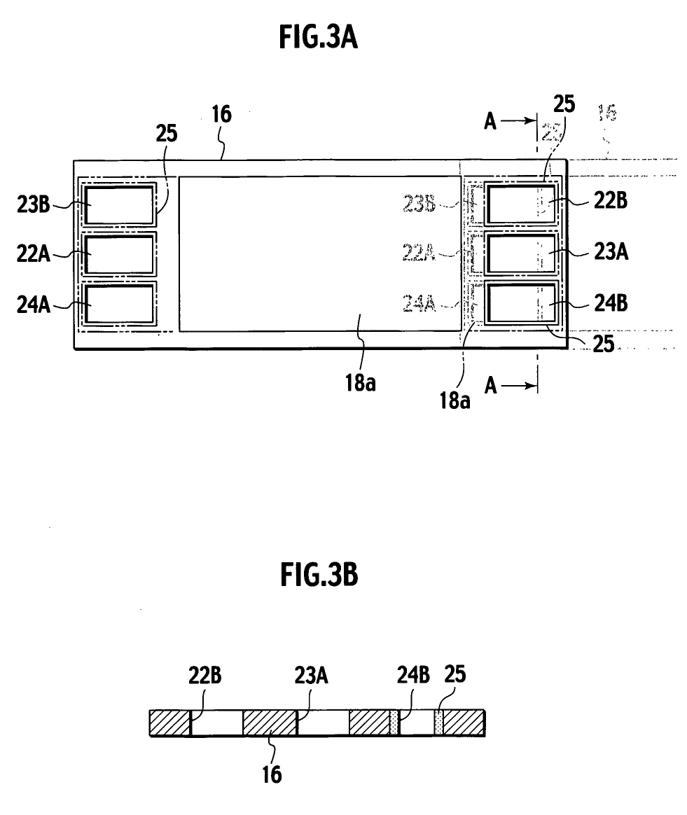

FIG. 1 is a schematic structural view of a fuel cell system of the presently filed embodiment; FIG. 2 is a cross-sectional view showing the fuel cell (fuel cell stack) of the presently filed embodiment in an enlarged size; FIG. 3A is a front view of an membrane electrode assembly (MEA: Membrane Electrode Assembly) as viewed in a direction X in FIG. 2; and FIG. 3B is a cross-sectional view taken on line A-A of FIG. 3A.

As shown in FIG. 1, the fuel cell system 1 includes the fuel cell stack 2 composed of a stack of unit cells, serving as a plurality of unit fuel cells, and the fuel cell stack 2 is provided with anodes 3 and cathodes 4, both depending on the number of unit cells.

Connected to the anodes 3 of the fuel cell stack 2 is a fuel supply line 6 forming a gas supply flow channel for fuel gas (hydrogen gas). The fuel supply line 6 is connected to a hydrogen supply source 8 from which hydrogen is supplied as fuel.

In the meanwhile, connected to the fuel cell stack 2 is a fuel exhaust line 7, serving a gas exhaust channel for fuel gas, through which gas, supplied from to the anodes 3 for reaction, is exhausted. Connected to the fuel exhaust line 7 is a hydrogen containing gas processor device 9, through which exhaust fuel gas is expelled.

Further, connected to the cathodes 4 of the fuel cell stack 2 is an oxidizer supply line 10 playing a role as a gas supply flow channel for oxidizer gas (air) to flow. Connected to the oxidizer supply line 10 is an oxidizer supply source 12 through which air is supplied as oxidizer. In the meantime, an oxidizer exhaust line 11 is connected to the fuel cell stack 2 as an exhaust gas flow channel for oxidizer gas through which hydrogen containing gas, resulting from reaction on the cathodes 4, is exhausted.

Furthermore, an electric control unit is connected to the anode 3 and the cathodes 4 of the fuel cell stack 2 by electric wirings 14 via an electric control unit 13. In FIG. 1, during electric power generating operation of the fuel cell 1, hydrogen gas and air flow in directions as shown by solid arrows a, b, respectively, and during electric power generation of the fuel cell 1, current flows in a direction as shown by a broken line c.

With such a structure of the fuel cell system 1, during electric power generation, the anodes 3 and the cathodes 4 of the fuel cell stack 2 are supplied with hydrogen gas as fuel gas from the hydrogen supply source 8 and air as oxidizer gas from the oxidizer supply source 12, respectively, to allow resulting electromotive force to be collected by the electric control unit 13 to be outputted.

As shown in FIG. 2, the fuel cell stack 2 is comprised of a stack body including a plurality of stacked unit cells 15 playing a role as unit fuel cells, respectively. The unit cell 15 includes the anode 3, serving as the fuel electrode, and the cathode 4, serving as the oxidizer electrode, between which an electrolyte membrane 16 is sandwiched. The anode 3 and the cathode 4 are provide with gas diffusion layers 17a, 17b and catalyst layers 18a, 18b, respectively. Moreover, the anode 3 is formed with a fuel gas flow channel 19 and the cathode 4 is formed with an oxidizer gas flow channel 20.

A stack body, composed of a plurality of unit cells 15 stacked in the fuel cell stack 2, includes the anodes 3 and the cathodes 4 that are alternately stacked in structure wherein separators 21 are sandwiched between individual fuel cells 15 and play a role as a fuel electrode separator and an oxidizer electrode separator in association with individual unit cells 15, respectively, for the purpose of separately supplying gases to the anodes 3 and the cathodes 4, respectively. The respective unit cells 15 are fixedly secured to each other by means of some suitable fixtures such as rods (not shown) penetrating through-holes formed at four corners of the unit cells 15. For the sake of convenience, although the separators 21 are shown in a unitary structure, each separator 21 has an anode side formed with a fuel gas flow channel facing the anode 3 and the other side formed with an oxidizer gas flow channel facing the cathode 4. Incidentally, the number of stacks of the stack body is exemplarily shown in four stacks, the present invention is not limited to such a number of stacks.

As hydrogen gas is delivered from the fuel supply line 6 (see FIG. 1) to the fuel cell stack 2, hydrogen gas is supplied to the fuel gas supply flow channels 19 formed in the anodes 3 of the individual fuel cells 15 by which the fuel cell stack 2 is defined. At the same time, as air is delivered from the oxidizer supply line 10 (see FIG. 1) to the fuel cell stack 2, air is supplied to the oxidizer gas flow channels 20 formed in the cathodes 4 of the individual fuel cells 15 forming the fuel cell stack 2. This allows the fuel cell 1 to generate electric power.

As shown in FIGS. 3A and 3B, the electrolyte membrane 16 has a substantially central area, on which the catalyst layer 18a (with the catalyst layer 18b being coated in the same way) is coated, and an outer peripheral area, beyond a region formed with the catalyst layer 18a, which is formed with a plurality of manifolds such as a hydrogen gas inlet manifold 22A, a hydrogen gas outlet manifold 22B, an air inlet manifold 23A and an air outlet manifold 23B.

Further, the electrolyte membrane 16 is formed with an LLC inlet manifold 24A and an LLC outlet manifold 24B serving as inlet and outlet for antifreeze liquid (LLC: Long Life Coolant) that contains ethylene glycol by weight of 50% serving as temperature conditioning medium by which temperatures inside the fuel cell 1 are regulated.

In addition to such a structure, the respective manifolds of the electrolyte membrane 16, that is, the hydrogen gas inlet manifold 22A, the hydrogen gas outlet manifold 22B, the air inlet manifold 23A, the air outlet manifold 23B, the LLC inlet manifold 24A and the LLC outlet manifold 24B are typically cut off through the use of a tool having a cutter blade with the substantially same shape as those of the manifolds. Thereafter, with a cutter blade formed in the same shape as that of such a tool being heated to a temperature equal to or greater than 350 [° C.] and equal to or less than 400 [° C.], the cutter blade is set to outer peripheries of the respective manifolds 22A, 22B, 23A, 23B, 24A, 24B again for executing heat treatment for a given time period.

As a result, ion diffusion preventive regions 25 are formed by thermally modifying polymer of certain regions of the electrolyte membrane 16 in distance from opening end portions of the respective manifolds 22A, 22B, 23A, 23B, 24A, 24B. However, in FIGS. 3A and 3B, for the sake of convenience, the ion diffusion preventive regions 25 has been shown only in respect of the LLC outlet manifold 24B at a portion thereof. Of course, it doesn't matter if the ion diffusion preventive regions 25 are formed in all of the manifolds in a manner as shown by a phantom line. Also, since constriction occurs in the electrolyte membrane 16 during thermal deformation, attempts may preferably be undertaken to preliminarily figure out the relationship among the temperatures, heating time intervals and degrees of constriction associated with deforming areas of the electrolyte membrane 16 to preclude a function of the electrolyte membrane 16 from being adversely affected.

Furthermore, while deformations of the electrolyte film 16 may include a mechanical increase in a density, a hardening, a reduction in water content and an increase of a degree of cross-linking, such deformations may also include reduction in a sulfonyl group in cases where a variety of positive ion exchange membranes, represented as perfluorosulfon acid, are used as the electrolyte membrane 16. Of course, the electrolyte membrane 16 may also include not only the various positive ion exchange membranes represented by perfluorosulfon acid but also a film made of material that belongs to hydrocarbon family.

In general, gaskets are located on both sides of the electrolyte membrane at peripheries of the manifolds for the purpose of preventing fluids, passing through the manifolds, from mixing with each other and fluids from leaking to an outside. However, since cutoff end faces of the electrolyte membrane are exposed to the opening ends of the manifolds, a probability takes place wherein a variety of ions pass from the exposed areas and sneak through areas beneath the gaskets for diffusion.

To address such issues, in view of preventing the ion diffusions from the respective manifolds 22A, 22B, 23A, 23B, 24A, 24B in which several ions flow, the presently filed embodiment contemplates to adopt a structure wherein the electrolyte membrane 16 is subjected to thermal deformation at peripheries of the respective manifolds 22A, 22B, 23A, 23B, 24A, 24B to perform ion diffusion preventive processing, that is, the ion diffusion preventive regions 25 are formed, whereby ions, contained in fluids flowing through the respective manifolds 22A, 22B, 23A, 23B, 24A, 24B, are prevented from mixing with fluids flowing through the other manifolds 22A, 22B, 23A, 23B, 24A, 24B.

Incidentally, it is, of course, to be appreciated that in cases where the catalyst is not adversely affected by fluids flowing through the respective manifolds 22A, 22B, 23A, 23B, 24A, 24B or if the ion diffusion preventive regions 25 clear off such an adverse affect, a surface area of the catalyst layer 18a (the same holds for the catalyst layer 18b) can be increased as shown by a phantom line in FIG. 3A to allow the respective manifolds 22A, 22B, 23A, 23B, 24A, 24B to be formed in a region of the catalyst layer.

As set forth above, with the presently filed embodiment, the ion diffusion preventive regions 25 are provided on peripheries of the hydrogen gas inlet manifold 22A, the hydrogen gas outlet manifold 22B, the air inlet manifold 23A, the air outlet manifold 23B, the LLC inlet manifold 24A and the LLC outlet manifold 24B, providing a capability of precluding metal ions, contained in fluids flowing through the manifolds 22A, 22B, 23A, 23B, 24A, 24B, from mixing with fluids flowing through the other manifolds 22A, 22B, 23A, 23B, 24A, 24B.

This enables a variety of metal ions, contained in condensed water, to be prevented from diffusing from the manifold cutoff end faces into the adjacent other fluid manifolds (the LLC inlet manifold 24A or the LLC outlet manifold 24B), while enabling the metal ions to be precluded from diffusing to the hydrogen gas inlet manifold 22A, the hydrogen gas outlet manifold 22B, the air inlet manifold 23A and the air outlet manifold 23B playing a role as the neighboring gas manifolds.

Further, intentionally altering the electrolyte membrane 16 on exposed areas thereof at the manifold cutoff end faces or a polymer structure of the electrolyte membrane 16 at peripheries of the manifolds makes it possible to restrict adsorption or diffusion of ions.

Thus, with the presently filed embodiment, a fuel cell 1 can be realized which is able to prevent metal ions from diffusing through the electrolyte membrane 16 for thereby suppressing deterioration in the electrolyte membrane 16.

Incidentally, while the presently filed embodiment has been described with reference to a structure wherein the ion diffusion preventive regions 25 are provided on all of the manifolds, that is, the peripheries (outer peripheries) of the hydrogen gas inlet manifold 22A, the hydrogen gas outlet manifold 22B, the air inlet manifold 23A, the air outlet manifold 23B, the LLC inlet manifold 24A and the LLC outlet manifold 24B, it is, of course, to be appreciated that the present invention is not limited to such a structure. The ion diffusion preventive regions 25 may be located, for example, on only the manifolds at areas closer to the fluid outlets, that is, only the hydrogen gas outlet manifold 22B, the air outlet manifold 23B and the LLC outlet manifold 24B. With such an alternative, ion diffusion preventive processing, by which the ion diffusion preventive regions 25 are formed, may be conducted at only desired areas to enable improvement in processing work efficiency for the ion diffusion preventive regions.

Moreover, while the presently filed embodiment has been described with reference to a case wherein the ion diffusion preventive regions 25 are formed at entire peripheries of the respective manifolds 22A, 22B, 23A, 23B, 24A, 24B, the present invention is not limited to such a case and the ion diffusion preventive regions 25 may be provided on the respective manifolds 22A, 22B, 23A, 23B, 24A, 24B only in areas at which adjacent manifolds (for example, the hydrogen gas outlet manifold 22B and the air inlet manifold 23A, or the air inlet manifold 23A and the LLC outlet manifold 24B) faces each other. Even with such an alternative, it becomes possible to obtain an ion diffusion preventive effect that is adequate in a practical use and ion diffusion preventive processing, for forming the ion diffusion preventive regions 25, is conducted only on minimal areas, thereby enabling further improvement in working efficiency.

Additionally, even if the ion diffusion preventive regions 25 are located only on areas, where the manifolds (the hydrogen gas outlet manifold 22B and the air inlet manifold 23A, the air inlet manifold 23A and the LLC outlet manifold 24B) adjacent to the manifold cutoff end faces of the electrolyte membrane 16 oppose each other, and on the catalyst layer 18, it becomes possible to obtain similar ion diffusion preventive effect and improvement in working efficiency.

### Second Embodiment

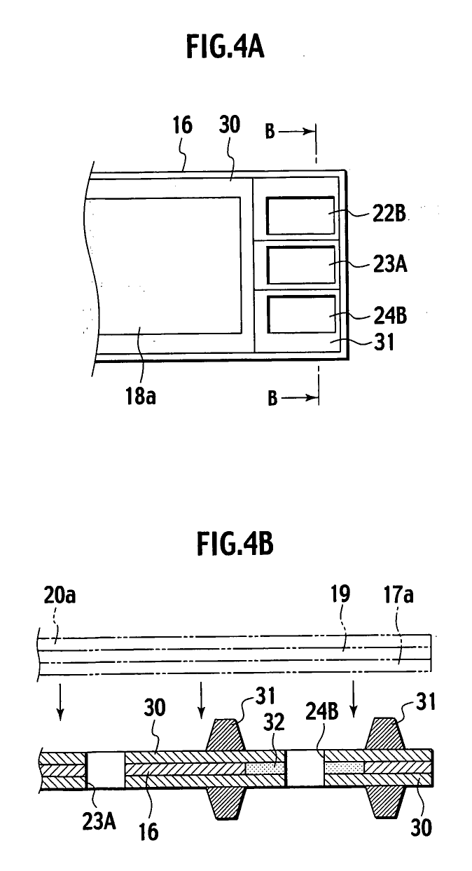

Next, a fuel cell of a second embodiment according to the present invention is described in detail with reference to FIGS. 4A and 4B.

FIG. 4A is a partial front view showing a membrane electrode assembly of the fuel cell of the presently filed embodiment and FIG. 4B is a partial cross-sectional view taken on line B-B of FIG. 4A.

The presently filed embodiment mainly differs from the first embodiment in respect of a structure of an ion diffusion preventive region. The same component parts bear like reference numerals and description is suitably simplified or omitted with a focus on such a differing point.

As shown in FIGS. 4A and 4B, the electrolyte membrane 16 has one surface and the other surface to which resin layers 30, made of insulating resin material such as polyethylene telephthalate (PET) and polyethylene naphthalate (PEN) are adhered by means of adhesive. Here, each resin layer 30 takes the form of a structure that is adhered to and joined with the electrolyte membrane 16 by means of adhesive to suppress gas leakage.

Further, the resin layer 30 is formed with resin manifold portions with the same shapes as those of the manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B) and these resin manifold portions play a role as manifold portions together with the associated manifolds formed in the electrolyte membrane 16. Incidentally, in the drawing figures, the resin manifold portions and the associated manifolds formed in the electrolyte membrane 16 bear reference numerals 22A to 24B in conjunction with each other. Also, the resin manifold portions are formed in the resin layer 30 in a process separate from that in which the manifolds are formed in the electrolyte membrane 16.

Furthermore, as shown in FIG. 4B, gaskets 31 are disposed on each resin layer 30 in areas close proximity to the resin manifolds to prevent fluids, such as gases and LLC serving as temperature conditioning medium, from mixing with each other and from leaking to the outside. Since the gas diffusion layer 17a, the fuel gas supply flow channels 19 and the anode side separator 21 (the same stands for the gas diffusion layer 17b, the oxidizer gas flow channels 20 and the cathode side separator 21) are stacked on the resin layer 30, the gaskets 31 are sandwiched between the resin layer 30 and the gas diffusion layer 17a, the fuel gas supply flow channels 19 and the anode side separator 21 with the gaskets 31 being compressed with an appropriate compression margin.

More particularly, the resin manifold portions are formed in diameters each of which is smaller than those of the respective manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B).

Therefore, clearances (interspaces) are formed between the electrolyte membrane 16 and the resin layers 30, between which the electrolyte membrane 16 is sandwiched, at areas close proximity to the manifolds, respectively, and filled with ion diffusion preventive resins 32 in a height equivalent to a thickness of the electrolyte membrane 16. That is, with the presently filed embodiment, the ion diffusion preventive resins 32 play a role as ion diffusion preventive regions.

The ion diffusion preventive resins 32 are not softened at operating temperature of the fuel cell system 1, that is, the fuel cell stack 2, and has an acid resistant characteristic in consideration of the occurrence of a contact with acid liquid droplets due to the location in the manifold portions. Especially in cases where the ion diffusion preventive resins 32 are used in the LLC inlet manifold 24A and the LLC outlet manifold 24B, the ion diffusion preventive resins 32 also have a low responsiveness with component substances of LLC.

As set forth above, with the presently filed embodiment, by permitting the both surfaces of the electrolyte membrane 16 to be sandwiched with the resin layers 30 and permitting the resin manifold portions to be formed in the resin layers 30, communicating with the respective manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B), each in an outer diameter smaller than those of the manifolds while locating the ion diffusion preventive resin 32, with a thickness substantially equal to that of the electrolyte membrane 16, in the interspace portion defined between the resin layers 30, it becomes possible to obtain the same ion diffusion preventive effect as that of the first embodiment.

In addition, with the presently filed embodiment, only permitting the ion diffusion preventive resins 32 to be disposed in the interspace portions defined between the resin layers 30 and the electrolyte 16 at the areas close proximity to the manifolds, set forth above, enables the same ion diffusion preventive effect as that of the first embodiment to be obtained, resulting in a capability of providing further improvement on assembling work efficiency and production efficiency of a fuel cell than those of the first embodiment.

### Third Embodiment

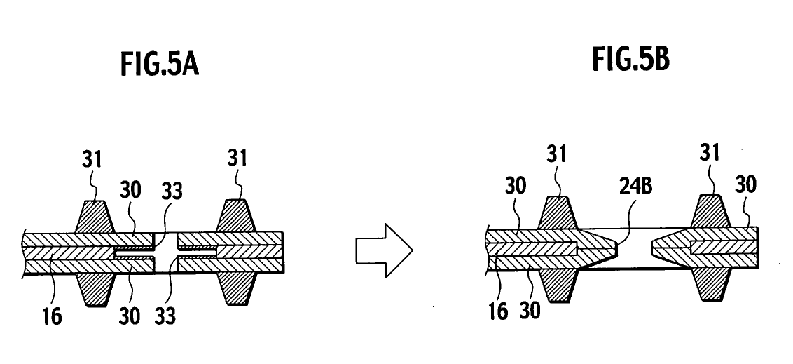

Next, a fuel cell of a third embodiment according to the present invention is described below in detail with reference to FIGS. 5A and 5B.

FIG. 5A is a partial cross-sectional view of an essential component part, prior to execution of ion diffusion preventive processing, of a membrane electrode assembly of the fuel cell of presently filed embodiment, and FIG. 5B is a partial cross-sectional view of the essential component part, subsequent to ion diffusion preventive processing being conducted, of the membrane electrode assembly of the fuel cell of the presently filed embodiment.

The presently filed embodiment mainly differs form the second embodiment in respect of a structure of an ion diffusion preventive region. Hereunder, the same component parts as those of the second embodiment bear like reference numerals and description is suitably simplified or omitted with a focus on such a difference.

As shown in FIG. 5A, with the presently filed embodiment, interspace portions between the resin layers 30 and the electrolyte membrane 16 at an area close proximity to the manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B) are provided with adhesives 33 in place of the ion diffusion preventive resins 32.

Then as shown in FIG. 5B, the resin layers 30, located on both surfaces of the electrolyte membrane 16 and extending from the electrolyte membrane 16 toward a central direction of the manifold, are joined to each other by adhesives 33, thereby covering cutoff end faces of the manifolds to which the electrolyte membrane 16 is exposed.

In such a way, by permitting manifold open end faces (manifold cutoff end faces) formed in the electrolyte membrane 16 to be covered with adhesives 33, various metal ions, contained in condensed water flowing across the manifolds, can be prevented from diffusing from the manifold cutoff end faces toward the adjacent other fluid manifolds (the LLC inlet manifold 24A or the LLC outlet manifold 24B).

As set forth above, with the presently filed embodiment, the both surfaces of the electrolyte membrane 16 are sandwiched with the resin layers 30 and the resin manifold portions, communicating with the respective manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B), are formed in the resin layers 30, respectively, each in an outer diameter smaller than those of the manifolds. This results in the interspace portions to which adhesives 33 are applied to allow the opposing resin layers 30 to be joined such that the manifold cutoff end faces of the electrolyte membrane 16 are covered. Thus, it becomes possible to obtain the same ion diffusion preventive effect as those of the first and second embodiments.

In addition, with the presently filed embodiment, only providing adhesives 33 to the interspace portions defined between the resin layers 30 and the electrolyte 16 at the areas close proximity to the manifolds, set forth above, enables the same ion diffusion preventive effect as that of the first embodiment to be obtained, resulting in a capability of providing further improvement in assembling work efficiency and production efficiency of a fuel cell than those of the first embodiment.

### Fourth Embodiment

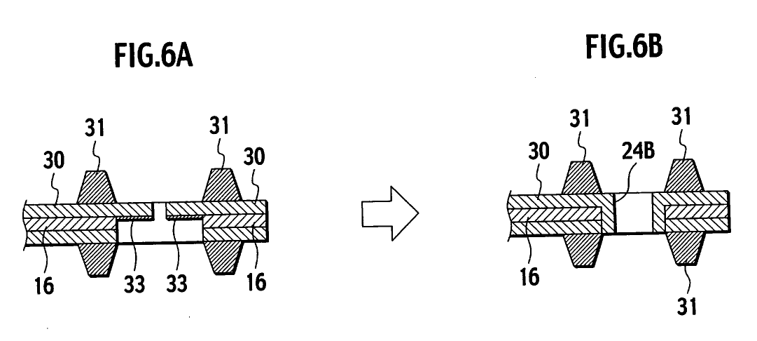

Next, a fuel cell of a fourth embodiment according to the present invention is described below in detail with reference to FIGS. 6A and 6B.

FIG. 6A is a partial cross-sectional view of an essential component part, prior to execution of ion diffusion preventive processing, of a membrane electrode assembly of the fuel cell of the presently filed embodiment, and FIG. 6B is a partial cross-sectional view of the essential component part, subsequent to ion diffusion preventive processing being conducted, of the membrane electrode assembly of the fuel cell of the presently filed embodiment.

The presently filed embodiment mainly differs form the third embodiment in respect of a structure of an ion diffusion preventive region. Hereunder, the same component parts as those of the third embodiment bear like reference numerals and description is suitably simplified or omitted with a focus on such a difference.

As shown in FIG. 6A, the presently filed embodiment mainly differs from the third embodiment in that resin manifold portions are formed on only one of the resin layers 30 in areas close proximity to the manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B), respectively, each with the substantially same outer diameter as that of the associated manifold.

More particularly, only a resin manifold portion of the resin layer 30, placed in an upper area in FIG. 6A, is set to have an outer diameter smaller than those of the manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B) and extends in a length to the extent available to cover a cutoff end face of the associated manifold of the electrolyte membrane 16.

Then, adhesive 33 is applied to the resin layer 30 (in the resin manifold portion whose outer diameter is small) in an area extending toward an inside of the associated manifold at a side adjacent to the electrolyte membrane 16 and the resin layer 30 is folded (or melted) and joined to the manifold cutoff end face of the electrolyte membrane 16 so as to cover the same as shown in FIG. 6B.

Like the third embodiment, this enables the manifold cutoff end face to be covered whereby various metal ions, contained in condensed water flowing across the manifold, can be prevented from diffusing from the manifold cutoff end face of the electrolyte membrane 16 to the other adjacent fluid manifolds (the LLC inlet manifold 24A or the LLC outlet manifold 24B).

As set forth above, with the presently filed embodiment, the both surfaces of the electrolyte membrane 16 are sandwiched with the resin layers 30, and the resin manifold portion of one of the resin layers 30, communicating with the respective manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B), is formed in a way to have an outer diameter smaller than those of the manifolds so as to allow the one of the resin layers 30 to be folded toward and joined to the opposing resin layer 30 in a way to cover the manifold cutoff end face thereof. Thus, it becomes possible to obtain the same ion diffusion preventive effect as those of the first and second embodiments.

In addition, with the presently filed embodiment, merely permitting one of the resin manifold portions formed on the resin layers 30 to be formed with an outer diameter smaller than those of the manifolds, while permitting the resin manifold portion to be folded toward and joined to the opposing resin layer 30, enables the same ion diffusion preventive effect as that set forth above to be obtained. This results in a capability for a size of the outer diameter of the manifold to be saved in a more efficient manner than that achieved by the third embodiment with the resultant further improvement on assembling work efficiency and production efficiency of a fuel cell than those of the first embodiment.

### Fifth Embodiment

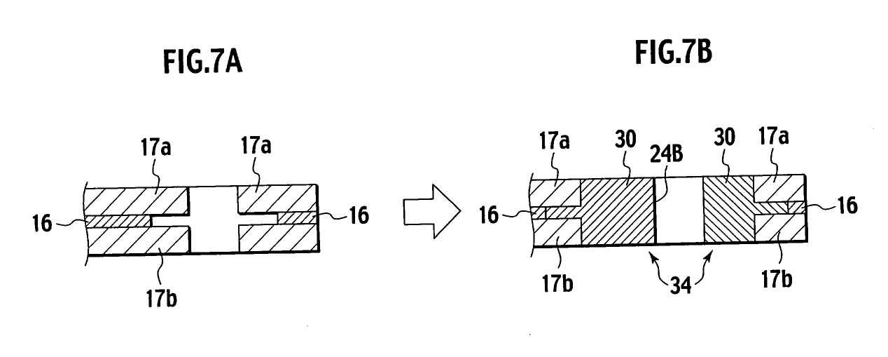

Next, a fuel cell of a fifth embodiment according to the present invention is described below in detail with reference to FIGS. 7A and 7B.

FIG. 7A is a partial cross-sectional view of essential component parts, prior to execution of ion diffusion preventive processing, of a diffusion layer and the membrane electrode assembly of the fuel cell of the presently filed embodiment, and FIG. 7B is a partial cross-sectional view of essential component parts, subsequent to ion diffusion preventive processing being conducted, of the diffusion layer and the membrane electrode assembly of the fuel cell of the presently filed embodiment.

The presently filed embodiment mainly differs form the first embodiment in respect of a structure of an ion diffusion preventive region. Hereunder, the same component parts as those of the first embodiment bear like reference numerals and description is suitably simplified or omitted with a focus on such a difference.

As shown in FIG. 7A, with the presently filed embodiment, the gas diffusion layers 17 (17a, 17b), located on both surfaces of the electrolyte membrane 16, are formed with manifold portions in association with the respective manifolds (i.e., the hydrogen gas inlet manifold 22A, the hydrogen gas outlet manifold 22B, the air inlet manifold 23A, the air outlet manifold 23B, the LLC inlet manifold 24A and the LLC outlet manifold 24B) while the manifold portions are formed in outer diameters, each of which is smaller than those of the associated manifolds and formed in assemblies.

Then as shown in FIG. 7B, a resin layer 30, made of resin material such as polyethylene telephthalate (PET) and polyethylene naphthalate (PEN), is provided to a clearance (interspace) between the electrolyte membrane 16 and the gas diffusion layers 17 (17a, 17b), and also to the manifold portions of the gas diffusion layers 17, thereby forming an ion diffusion preventive region 34 that covers a cutoff end face of the manifold of the electrolyte membrane 16.

Thus, by permitting the cutoff end face of the manifold of the electrolyte membrane 16 to be covered with the ion diffusion preventive region 34, various metal ions, contained in condensed water flowing across the manifold, can be prevented from diffusing from the manifold cutoff end face, formed in the electrolyte membrane 16, toward the adjacent other fluid manifolds (the LLC inlet manifold 24A or the LLC outlet manifold 24B).

Incidentally, it doesn't matter if the ion diffusion preventive region 34 is formed not by the resin layer 30, which is separately provided, but may be formed by permitting the gas diffusion layers 17 to be impregnated with insulation resin material from surfaces of the gas diffusion layers 17 in a way to cover the electrolyte membrane 16.

As set forth above, with the presently filed embodiment, the manifold portion is formed in the gas diffusion layers 17, located on both surfaces of the electrolyte membrane 16, with an outer diameter smaller than that of the associated manifold and formed in an assembly upon which the resin layers are located at the manifold portions of the gas diffusion layers 17 and the like to form the ion diffusion preventive region 34 to cover the manifold cutoff end face of the electrolyte membrane 16, thereby enabling the same ion diffusion preventive effect as those of the embodiments set forth above.

In addition, with the presently filed embodiment, it becomes possible to obtain the same ion diffusion preventive effect as that of the first embodiment set forth above merely by permitting resin material to be located in the gas diffusion layers 17 at the area close proximity to the manifold portion, resulting in a capability of providing further improvement on assembling work efficiency and production efficiency of a fuel cell than those of the first embodiment.

### Modifications of Various Embodiments

While the second to fifth embodiments have been described with reference to structures wherein the ion diffusion preventive processing, by which the cutoff end face (of the manifold open ends) of the electrolyte membrane 16 on the side facing the manifold are covered, and the ion diffusion preventive regions 34 are provided in all the manifolds, that is, the hydrogen gas inlet manifold 22A, the hydrogen gas outlet manifold 22B, the air inlet manifold 23A, the air outlet manifold 23B, the LLC inlet manifold 24A and the LLC outlet manifold 24B, such component elements may be locally provided on only desired manifolds (i.e., a manifold forming an outlet of fluid) and may not be provided in entire peripheries of the manifolds but may be provided only in portions opposing to the adjacent manifolds.

Such a structure is enabled to have advantages that include not only the ion diffusion preventive effects of the second to fifth embodiments but also remarkable improvement in working efficiency of ion diffusion protecting processing.

Further, while with the respective embodiments set forth above, gas and fluid are arranged to pass through the manifolds (internal manifolds) formed in the separators, gas and fluid may be used in a fuel cell wherein one of gas and fluid is associated with the internal manifolds and the other is associated with external manifolds. In this case, ion diffusion preventive regions may be located in areas where probabilities occur for medium, whose ions are probable to be diffused, to be mixed with the ions.

Furthermore, while with the various embodiments mentioned above, the manifolds are formed in the outer periphery beyond the region formed with the catalyst layer, similar advantageous effects can be obtained even if the manifolds, through which gas or fluid flow, are formed in an area where the above catalyst layer is formed on the electrolyte membrane and the ion diffusion preventive regions are provided in peripheral edge portions of openings of the manifolds such that the ions, contained in fluid, is not admixed with the above gas.

In addition, while with the embodiments set forth above, fluid has been described as including temperature conditioning medium, the present invention is not limited to such application and may be applied to a humidifying flow channel for use in an internally humidifying type fuel cell.

Moreover, while with the respective embodiments, the ion diffusion preventive regions have been provided in the manifold opening portions for fluid containing ions so as to preclude the ions from diffusing, the ion diffusion preventive regions may also be located in the manifold opening portions for gas such that the ions are not admixed to each other.

As set forth above, according to the present invention, among the manifolds formed in the electrolyte membrane, since the manifold for at least fluid has the opening end whose peripheral edge is provided with the ion diffusion preventive region to prevent the diffusion of the ions, the ions, contained in fluid passing across the manifolds, can be prevented from mixing to fluid flowing through the other manifolds.

Accordingly, various metal ions contained in condensed water can be prevented from impregnating and diffusing from the cross-sectional face (manifold cutoff end face), provided with the manifolds of the electrolyte membrane, to the other manifolds, thereby suppressing the occurrence of deterioration in the electrolyte membrane due to ion diffusion.

In addition, among the respective manifolds, the manifold for the outlet side of at least fluid, that is, only a desired area is locally provided with the ion diffusion preventive region and it is possible to obtain the ion diffusion suppression effect to be adequate on a practical use, thereby enabling further remarkable reduction in processing efficiency for ion diffusion preventive effect and further improvement in location working efficiency than those achieved in a case wherein the ion diffusion preventive regions are provided in all of the manifolds.

The entire content of a Patent Application No. TOKUGAN 2004-266747 with a filing date of Sep. 14, 2004 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As set forth above, with the fuel cell according to the present invention, among manifolds provided in an electrolyte membrane, a manifold of at least fluid has an opening whose peripheral edge portion provided with an ion diffusion preventive region, by which ions contained in such fluid are prevented from diffusion, and it becomes possible to suppress deterioration in an electrolyte membrane due to ion diffusion. Such a structure makes it possible to realize a fuel cell that is simple in structure and has a long operating life, with increased expectation on wide application ranges involving fuel cell powered vehicles.

1. A fuel cell comprising:
an electrolyte membrane;
a fuel electrode catalyst layer disposed on a first surface of the electrolyte membrane;
a fuel electrode separator disposed on the fuel electrode catalyst on a side thereof in opposition to the electrolyte membrane and having a fuel gas flow channel;
an oxidizer electrode catalyst layer disposed on a second surface of the electrolyte membrane, the second surface being in opposition to the first surface;
an oxidizer electrode separator disposed on the oxidizer electrode catalyst on a side thereof in opposition to the electrolyte membrane and having an oxidizer gas flow channel;
a plurality of manifolds formed in the electrolyte membrane and permitting at least one of fuel gas, oxidizer gas and temperature conditioning medium to flow; and
an ion diffusion preventive region provided on at least one open end peripheral edge portion of the plurality of manifolds to prevent ions, contained in fluid flowing through the at least one of the plurality of manifolds, from diffusing.

2. The fuel cell according to claim 1, wherein the ion diffusion preventive region includes a modified portion resulting from modifying the at least one open end peripheral edge of the electrolyte membrane.

3. The fuel cell according to claim 2, wherein the modified portion includes a thermally modified portion resulting from heating the electrolyte membrane.

4. The fuel cell according to claim 2, further comprising:
a pair of resin layers disposed between the electrolyte membrane and the fuel electrode separator and between the electrolyte membrane and the oxidizer electrode separator, respectively, each of the pair of resin layers having a resin manifold portion; and
an interspace portion defined between the electrolyte membrane and the pair of resin layers to be continuous with associated one of the plurality of manifolds;
wherein the ion diffusion preventive region is located in the interspace portion.

5. The fuel cell according to claim 4, wherein the resin manifold portion has a size smaller than that of associated one of the plurality of manifolds, and the ion diffusion preventive region includes an ion diffusion preventive resin disposed in the interspace portion.

6. The fuel cell according to claim 1, further comprising:
a pair of resin layers disposed between the electrolyte membrane and the fuel electrode separator and between the electrolyte membrane and the oxidizer electrode separator, respectively, each of the pair of resin layers having a resin manifold portion,
wherein the resin manifold portion has a size smaller than that of associated one of the plurality of manifolds, and the ion diffusion preventive region is formed by the pair of resin layers, each extending toward a center of the resin manifold portion thereof, which are joined to each other.

7. The fuel cell according to claim 6, wherein the ion diffusion preventive region is formed by permitting one of the pair of resin layers, each extending toward the center of the resin manifold portion thereof, to be folded toward the other one to be joined thereto.

8. The fuel cell according to claim 1, further comprising:
a pair of gas diffusion layers disposed between the electrolyte membrane and the fuel electrode separator and between the electrolyte membrane and the oxidizer electrode separator, respectively, each of the pair of gas diffusion layers having a manifold portion; and
an interspace portion defined between the electrolyte membrane and the pair of gas diffusion layers to be continuous with associated one of the plurality of manifolds,
wherein the ion diffusion preventive region includes resin provided to the interspace portion and the manifold portion of each of the pair of gas diffusion layers.

9. The fuel cell according to claim 8, wherein the manifold portion has a size smaller than that of associated one of the plurality of manifolds.

10. The fuel cell according to claim 8, wherein the ion diffusion preventive region is formed by permitting a surface of at least one of the pair of gas diffusion layers to be impregnated with resin.

11. The fuel cell according to claim 1, wherein the ion diffusion preventive region is provided in one, closer to an outlet adjacent to an inlet of at least one, of the plurality of manifolds.

12. The fuel cell according to claim 1, wherein the ion diffusion preventive region is provided between at least associated adjacent ones of the plurality of manifolds.

13. The fuel cell according to claim 1, wherein the ion diffusion preventive region is provided in all of the plurality of manifolds.

14. The fuel cell according to claim 1, wherein the ion diffusion preventive region is provided in an outer periphery beyond a range of the electrolyte membrane, in which the fuel electrode catalyst layer and the oxidizer electrode catalyst layer are disposed.

15. The fuel cell according to claim 1, wherein the ion diffusion preventive region is provided in an area other than a range of the electrolyte membrane, in which the fuel electrode catalyst layer and the oxidizer electrode catalyst layer are disposed.

16. A fuel cell comprising:
an electrolyte membrane;
a fuel electrode catalyst layer disposed on a first surface of the electrolyte membrane;
a fuel electrode separator disposed on the fuel electrode catalyst on a side thereof in opposition to the electrolyte membrane and having a fuel gas flow channel;
an oxidizer electrode catalyst layer disposed on a second surface of the electrolyte membrane, the second surface being in opposition to the first surface;
an oxidizer electrode separator disposed on the oxidizer electrode catalyst on a side thereof in opposition to the electrolyte membrane and having an oxidizer gas flow channel;
a plurality of manifolds formed in the electrolyte membrane and permitting at least one of fuel gas, oxidizer gas and temperature conditioning medium to flow; and
preventing means for preventing ions, contained in fluid flowing through the at least one of the plurality of manifolds, from diffusing, the preventing means being provided on at least one open end peripheral edge portion of the plurality of manifolds.
